(19) United States
(12) Patent Application Publication
(10) Pub. No.: US 2014/0101963 A1
(43) Pub. Date: Apr. 17, 2014

(54) Accessory for Recreational Vehicles

(71) Applicants: Louis Larabie, Chesterville (CA); Gladys Vargas, Chesterville (CA)

(72) Inventors: Louis Larabie, Chesterville (CA); Gladys Vargas, Chesterville (CA)

(21) Appl. No.: 13/929,439

(22) Filed: Jun. 27, 2013

Related U.S. Application Data
(60) Provisional application No. 61/712,769, filed on Oct. 11, 2012.

(51) Int. Cl. F26B 25/18

(52) U.S. Cl. CPC F26B 25/18
USPC 34/239

(57) ABSTRACT

A clothes drying rack for use with recreational vehicles disclosed, the rack being adapted to engage the supporting arms of a recreational vehicle ladder and including a plurality of through-holes that will accept standard clothes hangers or one or more rods extending therethrough for supporting clothes or other such articles.

The present invention relates in general to accessories for recreational vehicles and more particularly to a portable, removable board or rack that may be used as a clothes hanger/drier or as a device for hanging other articles therefrom.

### BACKGROUND OF THE INVENTION

Recreational vehicles take many forms, the main feature thereof being that they provide a “home away from home” for the campers, hunters, fishermen, sportsmen, and travelers that purchase or rent such vehicles. Recreational vehicles can be a small as a collapsible camper trailer that can be towed behind a compact automobile, or as large as a bus-based motor home. They can cost as little as a few thousand dollars for a new camper trailer or as much as a mansion, given that some motor homes are as luxurious as a mansion. Camper trailers can be spartan, without many amenities, and motor homes can include just about every convenience imaginable.

A large number of recreational vehicles are fairly modest, whether they be hard-sided trailers for towing behind a large automobile or SUV, so-called “fifth wheel” trailers for towing behind a suitably modified pickup truck, removable camper bodies for containment within the bed of a pickup truck, or self-driving motor homes built on van, truck or bus chassis. Such vehicles often include cooking facilities therein, but it is rare for such vehicles to include appliances for washing and drying clothes. Campers are often faced with either bringing enough clothes with them for a short vacation, or with finding coin-operated washing facilities at campgrounds or in towns or cities that they visit on their travels.

It is not uncommon for users of recreational vehicles to be more concerned with the drying of clothes than with the washing thereof, since washing can be done in streams adjacent a campground (not preferable for environmental reasons) or in the sink included in the vehicle itself. Also, if the occupants of the vehicle are at a campground with swimming facilities (a lake, river, or pool) then they are faced with having to dry bathing suits and towels after being in the water. The issue of drying towels and other fabric material has been addressed in U.S. patent application Ser. No. 12/006,630 of Jan. 4, 2008 through the provision of a rack that can be attached to and cantilevered from the ladder of a recreational vehicle, it being noted that many recreational vehicles are provided with a ladder at the rear thereof for permitting access to the roof of the vehicle. The rack of the US application is hooked onto a step of the ladder and extends rearwardly of the vehicle such that towels can be hung therefrom for drying. The rack of the prior art application has various disadvantages, including that it precludes anyone from climbing the ladder while the drier is in place. Further, when in use the rack can damage the rungs of the ladder, possibly twisting or deforming the same when under a load. The drier would have to be removed from the ladder to allow utilization of the ladder. Also, the drier rack of the application is bulky, and although the arms thereof are telescopic it would still take up considerable room when not in use.

### BRIEF DESCRIPTION OF THE INVENTION

The present invention overcomes the problems associated with the aforementioned US patent application by providing a simple, elongated rack that is adapted to engage the supporting arms or stanchions of a recreational vehicle ladder, behind the ladder and adjacent to the rear wall of the vehicle, the rack projecting to the side of the vehicle when in use rather than to the rear as with the rack of the US patent application. The present rack includes a plurality of through-holes that will accept standard clothes hangers or one or more rods extending therethrough for supporting towels or other such articles. The rack and accessory rods can be stored in a fabric case locatable within any storage locker of the vehicle. The rack can also be provided with means for supporting another ladder-like rack at right angles thereto so as to increase the capacity of the rack. Further, when used with a standard RV ladder, no additional tools are required to install or remove the rack of the present invention, thus saving time and storage space.

Generally speaking, the present invention may be considered as providing a rack for use as a support for clothes and other articles, the rack being elongated with upper and lower edges, front and rear surfaces, and end edges, there being a first slot extending inwardly of the rack from one of the end edges for engaging a first support arm provided on a wall with which the rack is to be used, a second slot spaced inwardly of the rack from the first slot and extending upwardly from the lower edge for engaging a second support arm provided on the wall and spaced laterally from the said first support arm, and means outboard of the second slot for supporting additional means from which the clothes and other articles may be suspended.

Furthermore, the present invention may be considered as providing a rack for removable attachment to a recreational vehicle having a vertically extending ladder thereon, such ladder being mounted to the vehicle by at least two laterally spaced apart supporting arms, the rack being elongated with upper and lower edges, front and rear surfaces, and end edges, there being a first slot extending inwardly of the rack from one of the end edges for sliding reception therein of one of the supporting arms, a second slot spaced inwardly of the rack from the first slot and extending upwardly from the lower edge for sliding reception therein of the other of the supporting arms, and means outboard of the second slot for supporting additional means from which clothes and other articles may be suspended.

### BRIEF DESCRIPTION OF THE DRAWINGS

FIG. 1 illustrates the rear of a typical recreational vehicle provided with a vertical access ladder supported by appropriate support arms.

FIG. 2 is a perspective view of a clothes drying rack in accordance with the present invention.

FIG. 3 shows a perspective view of the rack of the present invention in an operational position on the vehicle of FIG. 1.

FIG. 4 is a perspective view of the rack of the present invention showing an accessory rod utilized therewith.

FIG. 5 is a perspective view of the rack of the present invention showing an accessory rack in combination therewith.

FIG. 6 is a perspective view of the rack of the present invention with additional slots in the upper edge thereof for accepting additional hangers and a hinging option illustrated.

### DESCRIPTION OF THE PREFERRED EMBODIMENT

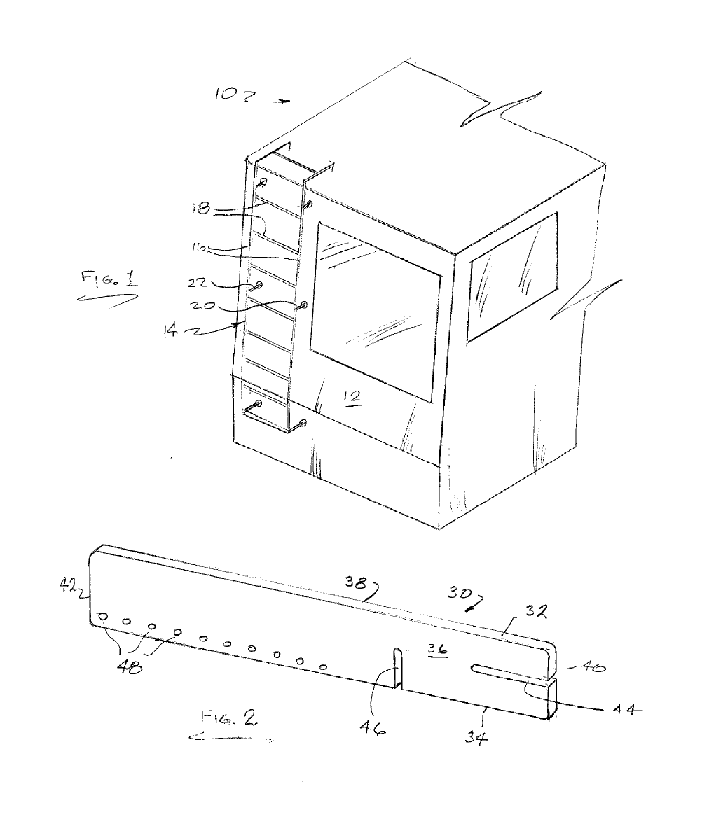

FIG. 1 shows the rear of a typical recreation vehicle, such as a trailer 10 that might be towed by a car, truck or SUV. The vehicle 10 could also be a self-driven vehicle such as a motor home. As can be seen the rear wall 12 of the vehicle is provided adjacent one side of the vehicle with a vertically extending ladder 14 having side rails 16 and vertically spaced steps 18. The ladder 14 is spaced outwardly from the rear wall of the vehicle to permit a climber's feet to rest comfortably on the steps 18, such spacing being achieved by inboard and outboard mounting or supporting arms 20, 22. The number of arms 20, 22 will depend on the height of the rear wall and the loads expected to be carried by the ladder.

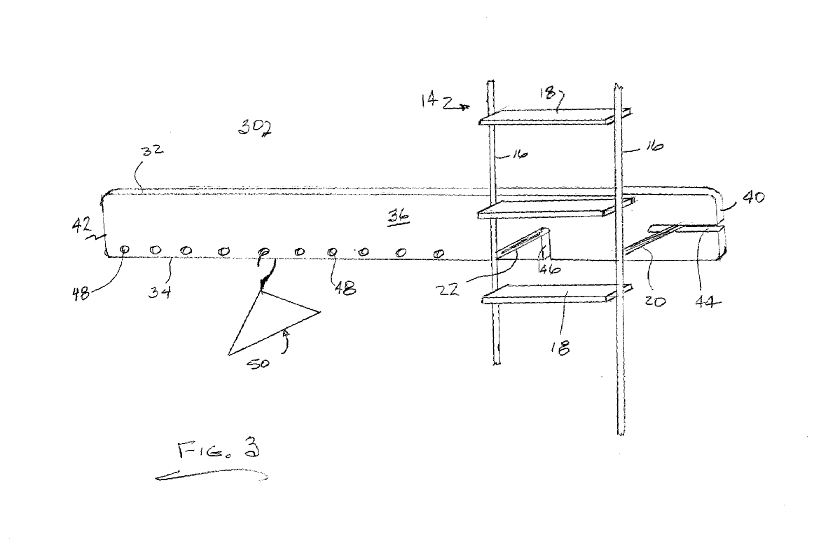

FIG. 2 shows in perspective the clothes drying rack 30 of the present invention. The rack is elongated and exhibits upper and lower edges 32, 34, front and rear surfaces 36, 38, and end edges 40, 42. The rack 30 can be made from wood, metal or plastic.

A first slot 44 extends inwardly from one of the end edges (40) and is sized to slidably receive one of the ladder supporting arms 20, 22. A second slot 46 extends upwardly from the lower edge 34 and is sized to slidably receive therein another of the ladder supporting arms 20, 22. The second slot is spaced inwardly of the rack from the one edge 40 and from the inner end of the first slot 44. The second slot extends upwardly a distance that places the end of the second slot at the same level as the upper edge of the first slot. A plurality of uniformly spaced-apart holes 48 extend through the rack between the front and rear surfaces 36, 38 with the holes 48 preferably being positioned adjacent the lower edge 34. While a single hole 48 would suffice to make the rack utile it is preferred that there be at least ten such holes for the sake of practicality.

FIG. 3 shows the rack 30 in its operable position for drying clothes. It is seen that the first slot 44 is in engagement with an inboard one 20 of the ladder support arms and that the second slot 46 is in engagement with the adjacent outboard one 22 of the ladder support arms such that the major portion of the rack extends laterally away from the side of the vehicle 10. It was very easy to place the rack in its operable position, with the rack being introduced behind the ladder at an angle so as to firstly engage the first slot 44 with the inboard support arm 20. The rack is slid inwardly along the rear of the vehicle so that the inward end of the slot 44 approaches the inboard support arm 20. When the second slot 46 is above the outboard support arm 22 the rack is pivoted downwardly so that the second slot 46 will engage the outboard support arm 22 and the upper end of the slot 46 will rest on the outboard support arm 22 thereby securing the rack in place. Clothes hangers 50 can then be hung from the through-holes 48 for drying or airing purposes.

While at the campground and when the drying rack is not required for operational use thereof it can be removed from its operational position of FIG. 3 and repositioned to rest against the rear wall 12 of the vehicle, with the first slot 44 engaging the outboard support arm 22 and the second slot 46 engaging the inboard support arm 20.

Since the first slot 44 is elongated, the rack of the present invention can accommodate ladders of different horizontal spacings between the support arms 20, 22.

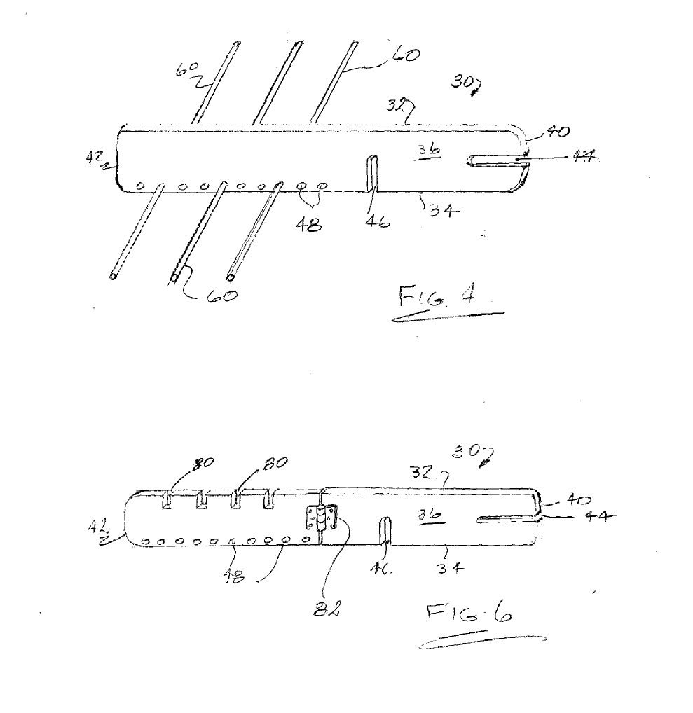

FIGS. 4 to 6 illustrate modifications to the basic rack as described above, which modifications increase the utility of the basic rack 30.

In FIG. 4 it is seen that one or more elongated cylindrical rods 60 are provided, each such rod being able to pass through any one of the through-holes 48 so as to extend outwardly of each of the side surfaces 36, 38. Towels or other articles can be draped over the rods 60 for drying or airing purposes. Regular clothes hangers can also be suspended from the rods 60.

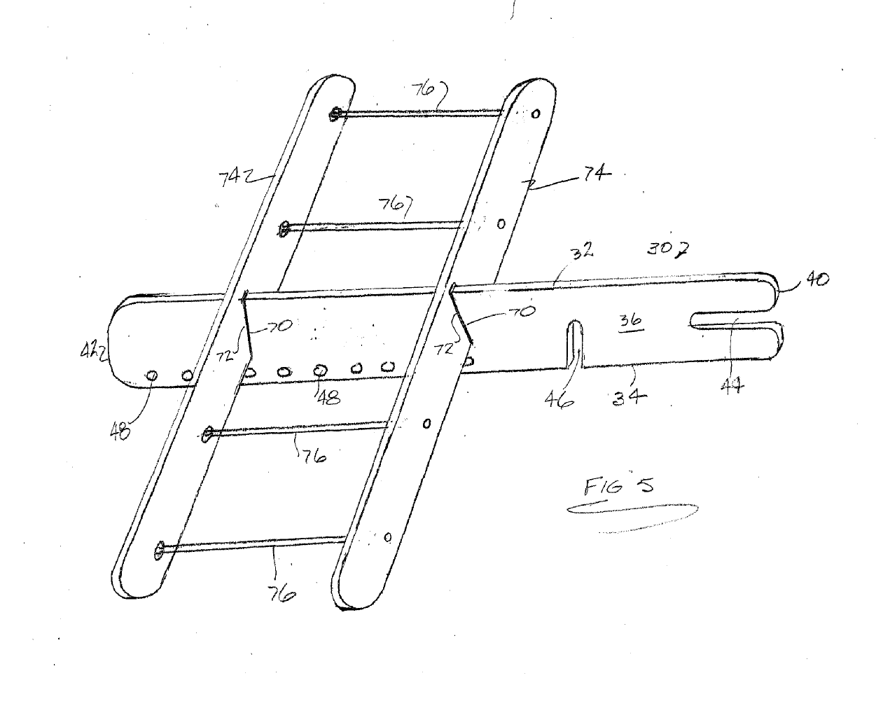

In FIG. 5 it is seen that the rack 30 is provided with a pair of spaced apart slots 70 extending downwardly from the upper edge 32, which slots interengage with matching slots 72 in each of a pair of boards 74, 74. Rods 76 extend between the boards 74, 74 and are spaced apart along the length of the boards on each side of the rack 30. The rods 76 can support towels or other articles draped thereover or can support regular clothes hangers suspended therefrom.

In FIG. 6 the upper edge 32 of the rack 30 is provided with a plurality of short slots 80 extending downwardly into the body of the rack for accepting additional clothes hangers.

It is clear that the present invention provides a simple solution for drying and/or airing clothes for individuals enjoying their recreational vehicles. The rack is solidly secured to the RV and is not adversely affected by wind. No additional means are required to secure the rack to the vehicle as long as the vehicle has a ladder with appropriate support arms. Should the vehicle not have a ladder it would be possible to provide a pair of support arms or stanchions as additional accessories for securement to a generally wall of a vehicle (including boats), or to a wall of a building or even to balconies. The rack can be contained within an accessory pouch for storage within the vehicle. The pouch could also be provided with securement means for attaching the pouch to the ladder such that the pouch need not be stored within the vehicle when the rack is not in use. The rack could be hinged in the middle as by hinges 82 shown in FIG. 6 or it could be made to be telescopic; however, such modifications could render the rack somewhat weaker even though it would be more compact for storage purposes. Other modifications and accessories could be provided without departing from the spirit of the present invention.

What is claimed is:

1. A rack for use as a support for clothes and other articles, said rack being elongated with upper and lower edges, front and rear surfaces, and end edges, there being a first slot extending inwardly of the rack from one of the end edges for engaging a first support arm provided on a wall with which the rack is to be used, a second slot spaced inwardly of the rack from said first slot and extending upwardly from said lower edge for engaging a second support arm provided on said wall and spaced laterally from said first support arm, and means outboard of said second slot for supporting additional means from which the clothes and other articles may be suspended.

2. A rack for removable attachment to a recreational vehicle having a vertically extending ladder thereon, such ladder being mounted to the vehicle by at least two laterally spaced apart supporting arms, the rack being elongated with upper and lower edges, front and rear surfaces, and end edges, there being a first slot extending inwardly of the rack from one of the end edges for sliding reception therein of one of the supporting arms, a second slot spaced inwardly of the rack from the first slot and extending upwardly from the lower edge for sliding reception therein of the other of the supporting arms, and means outboard of the second slot for supporting additional means from which clothes and other articles may be suspended.
